(19) United States
(12) Patent Application Publication
(10) Pub. No.: US 2001/0047295 A1
(43) Pub. Date: Nov. 29, 2001

(54) Equity rewards method

(76) Inventor: Samuel Sergio Tenembaum, New York, NY (US)

Correspondence Address: SAMUEL SERGIO TENEMBAUM, 2ND FLOOR, c/o 34 EAST 67 STREET, NEW YORK, NY, 10011, US

(21) Appl. No.: 09/765,889

(22) Filed: Jan. 22, 2001

Related U.S. Application Data
(60) Provisional application No. 60/175,903, filed on Jan. 31, 2000.
(60) Provisional application No. 60/190,077, filed on Mar. 17, 2000.
(60) Provisional application No. 60/202,061, filed on May 5, 2000.

(51) Int. Cl. G06F 17/60

(52) U.S. Cl. 705/14

(57) ABSTRACT

A new method of granting rewards to customers or to prospective customers, whereby the rewards are in the form of equity of the company granting them. This equity could be in the form of stock, warrants or stock options, bonds, convertible bonds. Customers would be eligible to rewards upon purchasing goods or services from the business that grants the equity rewards.

Also, according to this invention, businesses would be willing to grant equity rewards to customers or prospective customers who interact with the business advertisement, whether online or offline. Another embodiment envisages the grant of equity rewards to customers or prospective customers who succeed in attaining self-imposed goals. The equity rewards would be granted based on the customers or prospective customers' own word of honor, thus creating a reciprocate trusting bond between customers and businesses.

This application claims the benefit of U.S. Provisional Application No. 60/175,903 filed in the U.S. Patent and Trademark Office on Jan. 31, 2000, and U.S. Provisional Application number 60/190,077 filed in the U.S. Patent and Trademark Office on Mar. 17, 2000, and U.S. Provisional Application No. 60/202,061 filed in the U.S. Patent and Trademark Office on May 5, 2000; the entire contents of each Provisional Application being hereby incorporated by reference.

### FIELD OF THE INVENTION

The present invention relates generally to rewards programs. More particularly, the present invention relates to a new kind of rewards program suitable for businesses that wish to reward their customers' loyalty or potential customers at large.

### BACKGROUND

In the last few years we have witnessed a growing number of businesses that offer Rewards Programs to their customers as a brand loyalty incentive tool. Amidst fierce competition, businesses look for different tools to attract new customers and to keep existing ones. In such an environment, Rewards Programs have become increasingly popular.

A wide assortment of Rewards Programs are available, such as Mileage Programs, Points Programs, Cash Rebates, etc. Mileage programs are usually offered by airline carriers or general merchants (in association with certain airlines). They come in a variety of names (such as Frequent Flyer, Loyal Flyer, etc.). Customers who sign up to these programs get mileage credits for actual mileage flown (in case of airlines) or for goods/services purchased (in case of general merchants), according to different formulaes.

Points programs are in turn very popular with Credit Card Carriers, but not only with them. The come under different names (Membership Rewards, Stars, Points, etc.). The basic idea is to credit the customers with “virtual points” for every dollar spent, so that those points can be converted (based on different formulaes) into actual dollar credits against future purchases.

Cash rebates are rewards in actual cash, that can be either cashed or offset against future purchases. This kind of program is quite popular with Credit Card Carriers and general businesses alike.

Yet, none of the existing programs offer the ultimate loyalty incentive, i.e., equity rewards.

### SUMMARY

A need exists for a more innovative approach to meet the changing patterns of the consumer market. The present invention, referred to herein as “Equity Rewards Method” offers a new approach that yields benefits not previously realized. Our invention is based on the basic idea of rewarding a customer or a prospective customer by means of a much more potent method than the existing ones, in terms of enhancing customers loyalty. Instead of giving away mileage, points or cash, the company that grants the reward gives away equity, thus creating a self-thriving environment. The more the customer purchases from the business in question, the better off the business will be and the larger the participation of the customers themselves in the business' equity structure. The same rationale applies for prospective customers who by getting equity in a certain business will certainly be interested in its growth.

The Equity Rewards method has many advantages, both for the businesses as well as for the customers.

One advantage of the Equity Rewards for the businesses is that this method enhances brand awareness and customer loyalty. The more a customer buys, the larger participation he/she will have in the company. Or, if the Equity Rewards are granted to prospective customers, the more equity received by the prospective customer, the higher his/her motivation to become a regular patron of the business.

Another advantage for the businesses is that the Equity Rewards don't affect the cash flow position of the company.

Furthermore, Equity Rewards, create a larger trade volume for the underlying stock (in case of public companies).

One advantage of the Equity Rewards method for the customers is that this is an exciting way of becoming a stockholder in companies one really likes and knows. Furthermore, this method offers much better flexibility than the traditional rewards programs. If the granting business is a public company, the customers have the option to cash out as with regular rewards, or stay locked if they have trust in the future performance of the quoted security.

According to one embodiment of the present invention, the businesses granting the Equity Rewards can be Private Companies.

As such, Private Companies usually cannot offer their stock to the public at large (unless they go public, under a regulated procedure). Therefore, for this embodiment, our method contemplates the issuance of Stock Warrants, in a way similar to the adopted by private companies that plan a future Initial Public Offering (IPO) and wish to grant incentives to their existing employees and business partners, by means of establishing Stock Option Plans. The implementation of this embodiment would require the previous agreement of the exisisting stockholders.

Another possible embodiment would be one that contemplates Public Companies as the grantors of the Equity Rewards. Public Companies would have a great flexibility which will enable them in principle to offer a variety of equity instruments, such as stock, options, warrants, bonds (these instruments are not “equity instruments” per se but they are close to that definition since the owner of the bond is subject to the inherent risks of the bond issuer), convertible bonds, etc., all this in accordance to prevailing legal and accounting requirements.

Another embodiment of the present invention, contemplates the participation of Public or Private Companies in rewarding individuals with Equity Rewards in the framework of “We.b-Trust-and-Reward-You” programs (as per our Provisional Patent Application No. 60/190,077). According to this embodiment instead of granting awards to existing customers, the grantors offer Equity Rewards to individuals who manage to achieve self-imposed goals. Nowadays, businesses invest huge amounts of money to build up their image and brand awareness, in an effort to convince customers to trust them. This embodiment reverts the process. Individuals are trusted by businesses (since the latter grant the Equity Rewards based on the word of honor of the individual to the effect that he/she has managed to comply with his/her self-imposed goal) and this is bound to develop into a reciprocate trust. Individuals who feel trusted by businesses are most likely to put their own trust on those businesses.

According to yet another embodiment businesses that advertise on the Internet (or in other media), can offer Equity Rewards to people who interact in a certain way with their advertisements (as per our Provisional Patent Application No. 60/202,061). These individuals can be existing customers or not. In either case, this rewarding program will enhance the loyalty of exisisting customers and will create a strong bond with future customers.

### BRIEF DESCRIPTIONS OF THE DRAWINGS

The foregoing brief description, as well as further objects, features and advantages of the present invention will be understood from the following detailed description of presently preferred embodiments, with reference being had to the accompanying drawing, in which:

FIG. 1 is a system diagram depicting the relationships between various aspects of the Equity Rewards Method, in accordance with the present invention;

FIG. 2 is a flowchart of an exemplary method of using the Equity Rewards Method in accordance with one of the embodiments of the present invention.

### DETAILED DESCRIPTION

These and other aspects of the invention will now be described in greater detail in connection with a number of exemplary embodiments.

The present invention provides a method of granting rewards to existing customers or to prospective ones. The method comprises: establishing an arrangement between a Business and a Customer or a prospective Customer, under which, the former grants Equity Rewards to the latter, based on a certain qualitative and quantitative formulae. The qualitative part of the formula establishes the trigger for granting the Equity Reward. For instance, such trigger could be: a Customer purchases goods or services from the Business; or, an individual pledges to achieve a certain goal and declares to have accomplished that self-imposed objective; or, an individual interacts in a certain way with an online (or offline) advertisement placed by the Business.

The quantitative part of the formula establishes the mathematical relationship between the duty of the Customer and that of the Business.

Use of the term “Business” contemplates any stock corporation, whether private or public. Use of the term “Customer” or “Prospective Customer” contemplates any legal entity, whether individual or corporate.

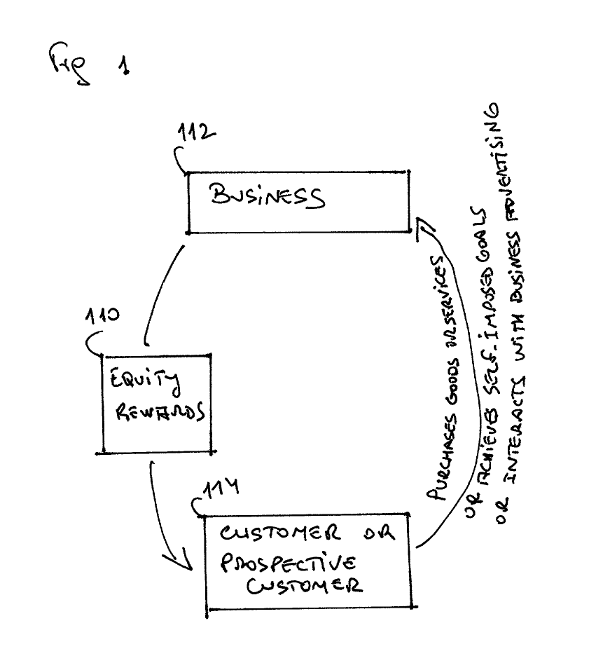

FIG. 1 is a system diagram depicting relationships between various aspects of the Equity Rewards Method. The Business 112 is the corporation that grants the Equity Rewards 110 to the Customer or the Prospective Customer 114. The Customer or Prospective Customer 114 may be an individual, a corporation, or any other legal entity capable of purchasing goods or services, capable of achieving self-imposed objectives, or capable of interacting with ads. The Customer or Prospective Customer 114 applies for the Equity Rewards 110 by filling out the appropriate application forms and providing the required information. The issuance of the Equity Rewards 110 involves the establishment of an agreement between the Business 112 and the Customer or Prospective Customer 114. This agreement stipulates the exact formula whereby the Customer or Prospective Customer 114 earns Equity Rewards 110. In accordance with one embodiment, the Business 112 is a Public Company that sells goods or services to the Customer 114 and offers its own stock as Equity Rewards 110. For example, the Business 112 might be an International Phone Carrier. Let's assume that at a given time, the stock of the International Phone Carrier quotes on the New York Exchange at U$S 100.—per share. The Stock Reward Program may contemplate the following ratio: For every U$S 100.—spent by the Customer 114 on phone calls, he/she will be entitled to receive one share of the International Phone Carrier at a discount price of U$S 99.—(i.e., a 1% rebate on the date the reward is given). At this stage, the Customer 114 may wish to sell the stock and convert this Stock Reward into a Cash Reward of U$S 1.—, or alternatively, if the Customer 114 believes the price of the stock is bound to go up, he/she may choose to keep it for future sale.

Another embodiment may contemplate a similar scenario with one major difference. Instead of granting Stock Rewards, the Business 112 grants Warrants. For instance, for every U$S 100.—spent on phone calls, the Customer 114 will get a Warrant with a fair market value of U$S 1.—. This Warrant will be a Call Option (Put Options will not be available for obvious company image reasons), and the Customer 114 will have the right to choose from different Call Options at the fair market value of U$S 1.—(if available), i.e., with different strike prices and or expiry dates. Similarly to the previous case, the Customer 114 will be free to choose whether to sell the Warrant immediately or to keep it for future expected gains.

Yet another embodiment contemplates the Business 12 granting Bonds or Convertible Bonds. For instance, for every U$S 100.—spent in calls, the Customer 114 will be entitled to receive a Bond or Convertible Bond with a fair market value of U$S 1.—. Same as in the previous case, the Customer 114 will be entitled to materialize his/her position at once or to stick with it.

A different embodiment altogether contemplates a scenario where the Business 112 is a Private Company. For example: let's assume that the Business 112 is a retail chain specialized in office supplies. For every U$S 100.—spent by the Customer 114, the Business 112 will grant a Warrant with a fair present market value of U$S 1.—(i.e., if one share of the Business 112 can be valued at U$S 100.—, then the Warrant will allow the Customer 114 to purchase that share at U$S 99). This Warrant will have an expiry date stipulated by the Business 112. The more distant the expiry date, the more attractive the Warrant will be.

Another embodiment contemplates a scenario where the Business 112 is Public or Private Company that advertises its goods/services over the Internet or over other offline media (TV, Newspapers, Radio, etc.). The Business 112 grants Equity Rewards 110 to the Customers or Prospective Customers 114 who interact in a certain way with the Business' advertisements. For instance, let's assume that the Business 112 is a soft drink manufacturer that places banner or any other advertising tool over the Internet. Let's assume further that in order to be eligible to Equity Rewards 110, the Customers or Prospective Customers 114 have to click through the Business 112 banner to log on to the Business 112 own website. By so doing, the Customer or Prospective Customer 114 becomes eligible to gain a certain Equity Reward 110, in the form of Stock, Warrant, Bond or Convertible Bond.

Another embodiment envisages a scenario where the Business 112 is interested in granting Equity Rewards 110 to Customers or Prospective Customers 114 who succeed in achieving certain auto-imposed goals. For instance, let's assume that the Business 112 is a Food Manufacturer. The Customers or Prospective Customers 114 sign up with a special website “We.b-Trust-and-Reward-You” and determine a certain pledge, such as: “In 12 weeks I'm going to lose 20 Pounds”. At the same time, the Customer or Prospective Customer 114 selects the Business 112 that will grant him/her the Equity Rewards 110, in case he/she succeeds to comply with his/her self-imposed goal. 12 weeks afterwards, the Customer or Prospective Customer 114 logs on the website and declares whether he/she managed to comply with his/her self-imposed goal. If affirmative, the Business 112 grants the Customer or Prospective Customer 114 the pre-established Equity Reward 110 (that could be in the form of Stock, Warrant, Bonds or Convertible Bonds).

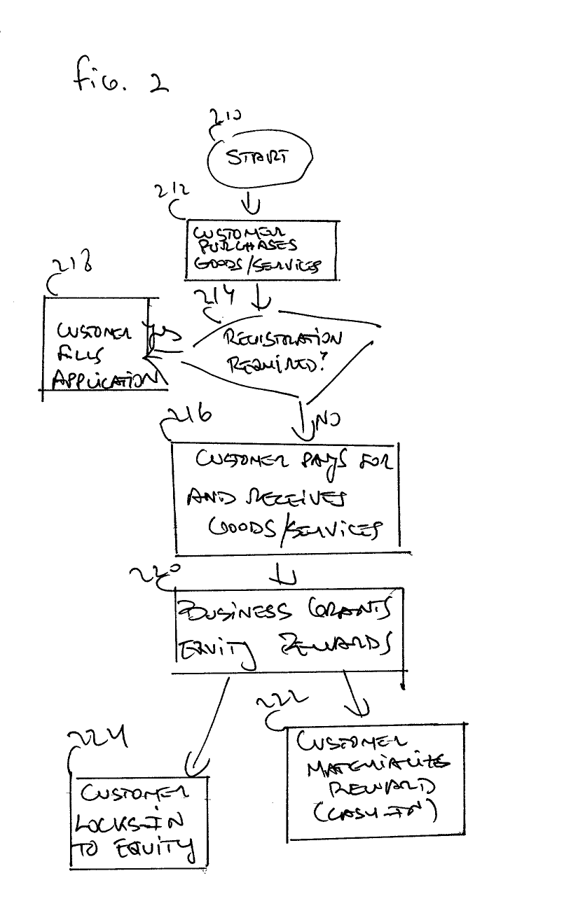

FIG. 2. is a flowchart of an exemplary method of the Equity Rewards, in accordance with one of the embodiments of the present invention. The method begins in step 210, and then proceeds to step 212 where the Customer purchases goods or services from the business. This purchase can be carried out online or offline. At this stage, the method proceeds to step 214 for handling registrations. If the Customer already applied for his/her unique Equity Rewards Account number, he or she may proceed to step 216. If not, the Customer must open an Equity Rewards Account number by filling up a special form. After doing so, the Customer may go on to step 216 and pay for the goods or services.

In step 220, the Business provides the Customer with the purchased goods or services and credits the Customer Equity Rewards Account with the appropriate Equity Rewards. In step 222, the Customer opts for cashing the Equity Rewards, whereas in step 224 the Customer opts to keep the Equity Rewards for future materialization. The aforementioned embodiments and description of the present invention are intended to be illustrative rather than restrictive. Many variations of implementing the present invention may be derived from the description contained herein by a person skilled in the art. All such variations and modifications are considered to be within the scope and spirit of the present invention, as defined by the following claims:

What is claimed is:

1. A method of granting Equity Rewards to Customers, the method comprising:
establishing an agreement between the Business that grants the Equity Rewards and the Customer that receives these Equity Rewards.
establishing both a quantitative and a qualitative relationship between the purchase of goods or services that triggers the grant of Equity Rewards and the Equity Rewards themselves.

2. The method of claim 1., wherein the Business granting the Equity Rewards is a Public Company.

3. The method of claim 1., wherein the Equity Rewards are in die form of stock.

4. The method of claim 1., wherein the Equity Rewards are in the form of Warrants or Stock Options.

5. The method of claim 1., wherein the Equity Rewards are in the form of Bonds.

6. The method of claim 1., wherein the Equity Rewards are in the form of Convertible Bonds.

7. The method of claim 1., wherein the Business granting the Equity Rewards is Private Company.

8. A method of granting Equity Rewards to Customers or Prospective Customers, the method comprising:
establishing an agreement between the Business that grants the Equity Rewards and the Customer that receives these Equity Rewards.
establishing both a quantitative and a qualitative relationship between the Customer or Prospective Customer's interaction with the Business' advertising that triggers the grant of Equity Rewards and the Equity Rewards themselves.

9. The method of claim 8, wherein the Business advertising is on the Internet.

10. The method of claim 8, wherein the Business advertising is on any other traditional media, such as newspapers, TV, Radio, Billboards, etc.

11. The method of claim 8, wherein the Business granting the Equity Rewards is a Private Company.

12. The method of claim 8, wherein the Business granting the Equity Rewards is a Public Company.

13. The method of claim 8, wherein the Equity Rewards are in the form of stock.

14. The method of claim 8, wherein the Equity Rewards are in the form of Warrants or Stock Options.

15. The method of claim 8, wherein the Equity Rewards are in the form of Bonds.

16. The method of claim 8, wherein the Equity Rewards are in the form of Convertible Bonds.

17. A method of granting Equity Rewards to Customers, the method comprising:
establishing an agreement between the Business that grants the Equity Rewards and the Customer that receives these Equity Rewards.
establishing both a quantitative and a qualitative relationship between the Customer or the Prospective Customer's success in his/her self-imposed goal that triggers the grant of Equity Rewards and the Equity Rewards themselves.

18. The method of claim 17, wherein the Business granting the Equity Rewards is a Private Company.

19. The method of claim 17, wherein the Business granting the Equity Rewards is a Public Company.

20. The method of claim 17, wherein the Equity Rewards are in the form of stock.

21. The method of claim 17, wherein the Equity Rewards are in the form of Warrants or Stock Options.

22. The method of claim 17, wherein the Equity Rewards are in the form of Bonds.

23. The method of claim 17, wherein the Equity Rewards are in the form of Convertible Bonds.
